(19) United States
(12) Patent Application Publication
(10) Pub. No.: US 2012/0105171 A1
(43) Pub. Date: May 3, 2012

(54) CROSS POLARIZATION MULTIPLEXER

(76) Inventor: Sebastiano Nicotra, ALCALA DE HENARES (Madrid) (ES)

(21) Appl. No.: 13/282,813

(22) Filed: Oct. 27, 2011

Related U.S. Application Data
(63) Continuation of application No. PCT/ES2010/070192, filed on Mar. 30, 2010.

(30) Foreign Application Priority Data
Apr. 28, 2009 (ES) P200901105

(51) Int. Cl. H01P 5/12; H01P 1/165

(52) U.S. Cl. 333/137; 333/21 A

(57) ABSTRACT

The invention relates to a cross polarization multiplexer which doubles the capacity of radio links using a vertical polarization diplexer (1), a horizontal polarization diplexer (2) and an octagonal transducer module (3) for separating the vertically polarized waves from the horizontally polarized waves. The invention is characterized in that the vertical diplexer (21) and the horizontal diplexer (22) are integrated in a module (23) forming a monobloc body having a specific, simple and inexpensive configuration. This configuration allows the use a single transceiver unit (34) which also provides a cost saving.

### OBJECT OF THE INVENTION

The invention relates to a cross polarization multiplexer intended to double the capacity of radio links, for which simultaneously works with vertical polarization waves and horizontal polarization waves; and which is intended to obtain a cross polarization multiplexer formed by a monobloc body that integrates a vertical polarization diplexer, a horizontal polarization diplexer and an octagonal transducer (OTM) that performs the separation of vertically polarized waves from the horizontally polarized waves, providing a specific, simple and inexpensive structure.

Therefore, the invention is applied to the field of telecommunications, and more specifically to the radio links.

### BACKGROUND OF THE INVENTION

Currently, radio links are widely used for accessing the wireless LAN or mobile phone base stations, as an easy solution to be implemented and at a competitive cost.

However, the telecommunications market calls for a continuous increase of its capacities and lower costs.

This increase in the capacities being requested is facing the limits of the occupation of the spectra, the existing technologies and the cost that all this involves.

Currently there are three ways to increase the net capacity:
1) To increase the levels of modulation, that causes problems of linearity and sensitivity against the noise. The current limit is in the 256QAM.
2) To increase the bandwidth, which is internationally regulated, and only allows high bandwidth for links from 60 to 80 GHz and at these frequencies the distances of these links are unacceptably short, therefore it is not viable.
3) To double the capacity using two different links, both operating at the same frequency with cross polarizations. This possibility is rarely used by being very complex and expensive. Regarding this third point, the most used solution consist of coupling a single antenna to two transceiver units (transmitter and receiver), one which works with vertical polarization and one which works with horizontal polarization, through an octagonal transducer module (OTM, Ortho Mode Transducer) that separates the vertically polarized waves from the horizontally polarized waves.

The two transceiver units are controlled by a single input control unit known as IDU, which has a very expensive and complex configuration.

Therefore, this solution requires for each of the two terminals that make up a radio link, an IDU, two radio units, an OTM module and an antenna, which is a complex, costly and low reliability device.

The invention doubles the capacity of radio links, in accordance with paragraph 3, only using for this a single transceiver unit with the cross polarization multiplexer included therein and an antenna, which eliminates the need to use a second transceiver unit, the OTM external module and the IDU unit, which considerably simplifies the structure of this type of devices and significantly reduces their cost.

### DESCRIPTION OF THE INVENTION

To achieve the objectives stated above, the invention provides a cross polarization multiplexer, which like those provided in the state of the art doubles the capacity of radio links by simultaneously working with vertically polarized waves and horizontally polarized waves, using a vertical polarization diplexer, a horizontal polarization diplexer and an octagonal transducer (OTM), and which has as essential novelty that the vertical diplexer and the horizontal diplexer are integrated with the OTM module forming a monobloc body. For such purpose, said OTM module includes a square waveguide having an insulation structure between the vertically polarized waves and the horizontally polarized waves, comprising a first input and output window for the vertically polarized waves through which the OTM module is connected to a second window of the vertical diplexer. Additionally, the OTM module is equipped with a third input and output window for the horizontally polarized wave that makes up the means of connection of a fourth window of the horizontal diplexer. In this structure the first, second, third and fourth windows are inaccessible from outside the monobloc body which provides a compact and inexpensive structure. Additionally, the OTM module is equipped with a fifth window which is the means of connection to an antenna.

Both the vertical diplexer and the horizontal diplexer have a sixth and seventh window for connection to the board that contains, among other circuits, the transmitter circuit and the receiver circuit of the radio unit; so that said sixth and seventh windows, as well as the fifth window for connecting to the antenna of the OTM module, are located on the same plane and make up the only external access to the monobloc body. Such monobloc body is covered by a closure and protective cover which is common to the OTM module and the horizontal and vertical diplexers, and has a flat configuration wherein the fifth, sixth and seventh windows are included, so that these are located in a same plane, allowing an easy interface with the board that contains the transceiver circuit.

In the preferred embodiment of the invention, the outer portion of the cover includes some channelings that make up a mask for removing the radiations of millimeter waves radiated from the circuit board that contains the transceiver circuit. To this end, said circuit board is coupled over the cover, forming a single assembly.

The configuration described provides a monobloc body of compact and simple structure, obtaining of which represents a much reduced cost compared to those described in the state of the art.

The waveguide of the OTM module includes the fifth window for connecting to the antenna connection at the top, and includes some asymmetrical steps, against which the first input and output window for the vertically polarized waves is arranged, and its bottom wherein the steps end, comprises the third input and output window for the horizontally polarized waves. In the configuration described, the first and third windows are arranged in directions that form an angle of 90° to obtain the necessary isolation that avoids cross-influences between the of vertical and horizontal polarization diplexers, thus achieving the correct transmission and reception of polarized waves.

In addition, the third input and output window for the horizontally polarized waves of the OTM module has a rectangular configuration and is connected to an double-curve waveguide adapting unit connected to the fourth window of the horizontal diplexer, so that this connection is inaccessible from the outside, which allows obtaining the compact monobloc body.

The first input and output window for the vertically polarized waves of the OTM module, has a rectangular configuration which coincides with the second window of the vertical diplexer.

Regarding the configuration of the fifth window of the cover, it should be noted that it has a square or circular configuration in order to perform the connection to the antenna.

In connection with the sixth and seventh windows, it should be noted that these may have different configurations, such as rectangular, square, circular or elliptical.

The filters conventionally included by the diplexers are tuned to the same frequency band, so that those in one side are tuned on the low frequency band and those on the opposite side to the high frequency band for performing the transmission and reception, or vice versa, according to the configuration of the radio unit.

Next to provide a better understanding of this specification and being an integral part thereof, a series of figures in which the object of the invention has been represented in an illustrative and not limitative manner, is attached.

### BRIEF DESCRIPTION OF THE FIGURES

FIG. 1.—Shows a perspective view of the state of the art closest to the invention which has been shown to dearly establish the differences of the state of the art against the invention.

FIG. 2.—Shows an exploded perspective view of the cross polarization multiplexer of the invention, in which has been represented its coupling to the board that contains, among other circuits, the transmitter circuit and the receiver circuit of the radio unit.

FIG. 3.—Shows a view along a longitudinal section of the multiplexer of the previous figure but with its elements mounted.

FIG. 4.—Shows a cross-sectional view of FIG. 2 without the circuit board that contains the transmitter circuit and the receiver circuit, with its elements mounted.

### DESCRIPTION OF THE PREFERRED EMBODIMENTS

A description of the invention based on the figures mentioned above is made below.

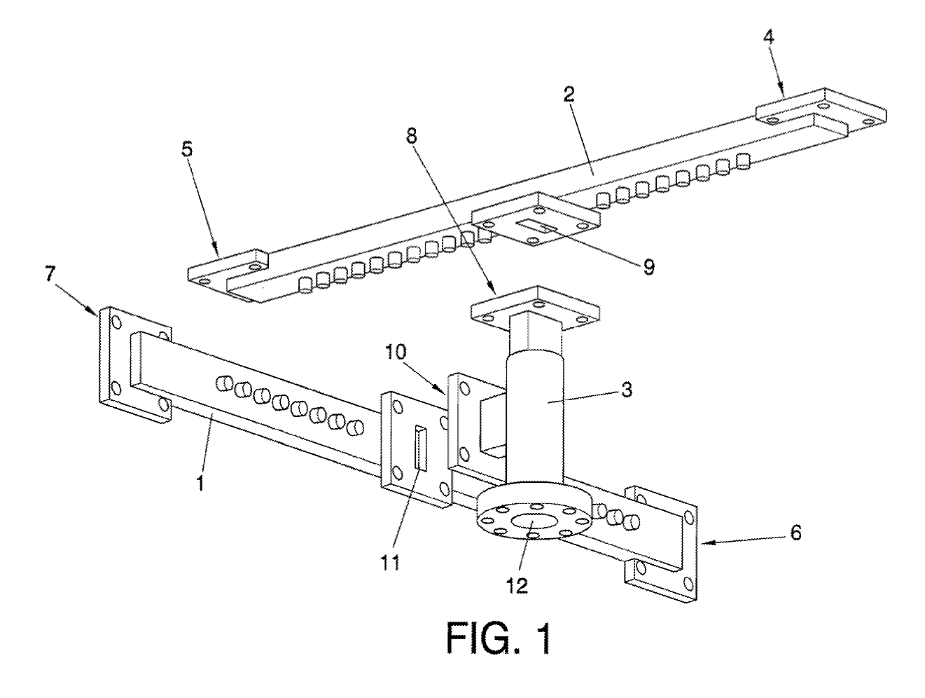

Firstly and with the help of FIG. 1 the current state of the art is described in order to facilitate the understanding of the novelty of the invention.

The conventional solution provides for the connection to a single antenna and through an OTM module (3), with two radio units that work with cross polarization. In FIG. 1 and to facilitate the understanding, only the diplexers integrated into each of the radio unit are shown, by being the connecting elements to the outside for both the reception and transmission of vertically polarized waves and horizontally polarized waves.

The conventional solution in FIG. 1 shows a vertical polarization diplexer (1) that belongs to the radio unit that transmits and receives vertically polarized waves through windows (6) and (7).

It also comprises a horizontal polarization diplexer (2) that belongs to the radio unit that transmits and receives horizontally polarized waves through windows (4) and (5).

Both diplexers (1) and (2) are connected to the octagonal transducer module OTM (3) that is responsible for separating the vertically polarized waves from the horizontally polarized waves. For such purpose, the vertical polarization diplexer is equipped with an input and output window (11) that is connected to an input and output window (10) of the OTM module (3); and the horizontal polarization diplexer (2) is equipped with an input and output window (9) connected to an input and output window (8) of the referred OTM module (3).

The configuration described in FIG. 1, is completed with the addition of an input and output window (12) of the OTM module (3) through which is made the connection to an antenna that transmits and receives vertically polarized waves and horizontally polarized waves, thus doubling the capacity of the radio link, for which also requires the addition of an entry and control unit (IDU) not shown, which controls the operation of the two radio units. Such solution is complex, costly and low reliability.

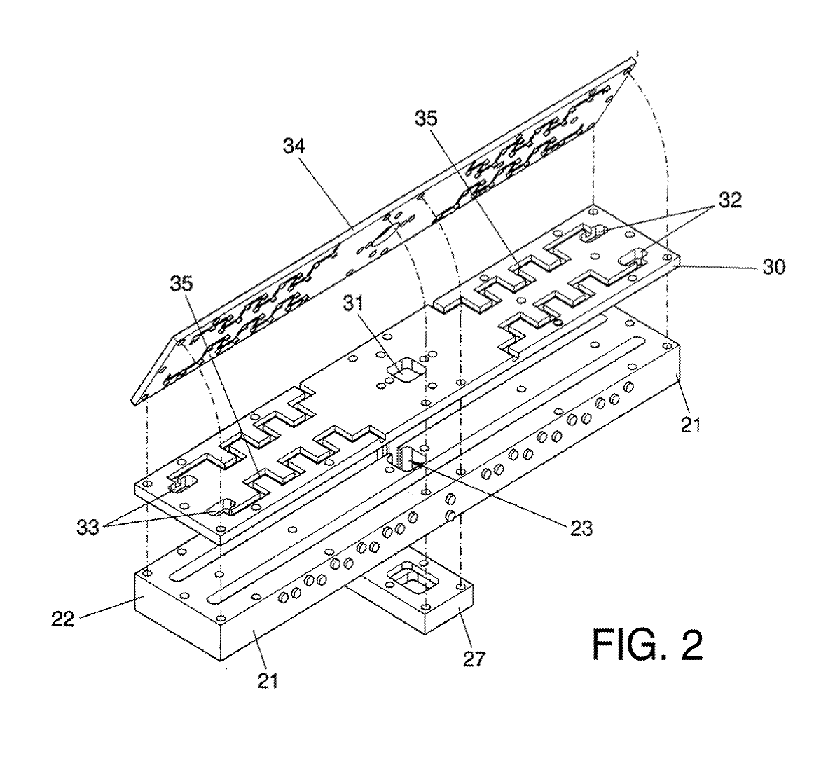

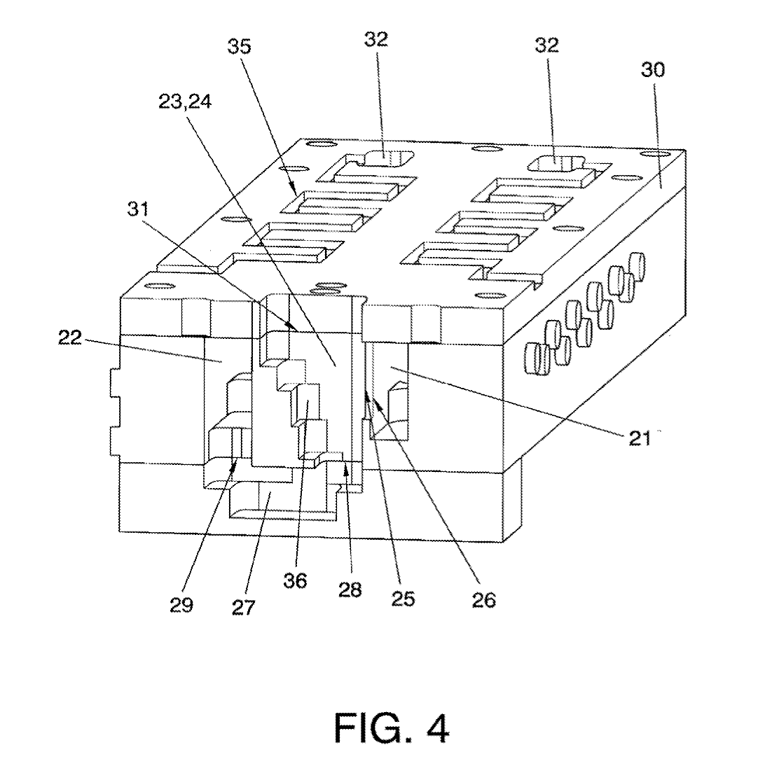

The invention of the cross polarization multiplexer, provides a very low cost solution, FIGS. 2 and 4, which presents the peculiarity that the vertical polarization diplexer (21), the horizontal polarization diplexer (22) and the OTM module (23) are integrated forming a monobloc body.

For such purpose, the OTM module (23) comprises a square waveguide (24) that includes a first input and output window (25) for the vertically polarized waves, through which the connection to the vertical polarization diplexer (21) is made through a second window (26) contained therein.

To perform the connection of the OTM module (23) to the horizontal diplexer (22), a double-curve waveguide adapting unit (27) is provided, which connects a third input and output window (28) for the horizontally polarized waves of the OTM module (23) to a fourth window (29) of the horizontal polarization diplexer (22).

The OTM module (23) comprises four asymmetrical steps (36) through which the horizontally polarized waves contained in the square waveguide (24), are guided through the third input and output window (28) to the double-curve waveguide adapting unit (27), through which the fourth window (29) of the horizontal polarization diplexer (22) is reached.

The second window (26) of the vertical diplexer (21) is situated opposite to the asymmetrical steps (36) in order to direct the vertically polarized waves to the vertical polarization diplexer (21).

Therefore, the first window (25) and the third window (28) of the OTM module (23) are arranged in directions forming an angle of 90° which allows obtaining the proper insulation avoiding the inter-influences between the vertical (21) and horizontal (22) polarization diplexers.

The first input and output window (25) has a rectangular configuration and is coincident with the second window (26) of the vertical diplexer (21).

The monobloc body has a flat cover (30) for closure and protection, which is common to the OTM module (23) and to the horizontal (22) and vertical (21) polarization diplexers. The cover (30) comprises a fifth window (31) which is part of the OTM module (23) through which the connection to the antenna, not shown in the figures, is made.

The fifth window (31) has a square or circular configuration.

In addition, the cover (30) is equipped with a sixth window (32) and a seventh window (33) that are part of the vertical polarization diplexer (21) and the vertical polarization diplexer (22), and which make up the means of connection to the board (34) containing, among others, the transmitter circuit and the receiver circuit of the radio unit.

The sixth (32) and seventh (33) windows have a rectangular, square, circular or elliptical configuration.

The cover (30) has a flat configuration that allows an easy connection interface to the board (34) that contains the transmitter circuit and the receiver circuit.

The described configuration allows obtaining the monobloc body by machining from one of its side and closing with the cover (30), which results in high strength, very low cost and high reliability.

The cover (30), besides being a means for closing and protecting the monobloc body, serves as a protection against radiation of millimeter waves irradiated in the board (34). For such purpose, on the outside of the cover (30) holes and channelings (35) that form a mask that blocks and removes said radiations are machined.

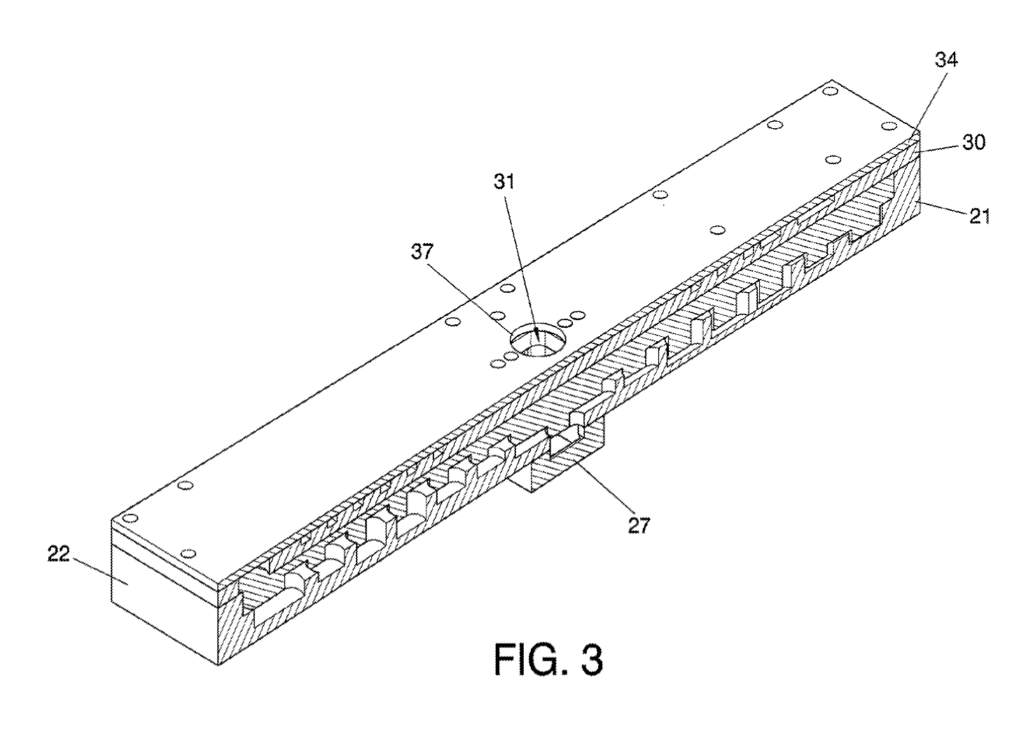

Therefore, the board (34) containing the transmitter and receiver circuit is directly coupled over the cover (30) forming a single compact and simple assembly, FIG. 3.

The board (34) containing the transmitter and receiver circuit comprises a window (37) through which the connection of the fifth window (31) to the antenna is made.

Therefore, the described structure has a compact monobloc configuration which only require the use of a single transceiver radio unit in order to simultaneously work with vertically polarized waves and horizontally polarized waves, doubling the capacity of radio links, simplifying the structure of the installation, and reducing the cost in a very significantly manner and increasing the reliability of the link.

1. Cross polarization multiplexer, which doubles the capacity of radio links by simultaneously working with vertically polarized waves and horizontally polarized waves, using a vertical polarization diplexer (1), a horizontal polarization diplexer (2) and an octagonal transducer module (OTM) (3) for separating the vertically polarized waves from the horizontally polarized waves, characterized in that the vertical diplexer (21) and the horizontal diplexer (22) are integrated in the OTM module (23) forming a monobloc body, for which said OTM module (23) includes a square waveguide having an insulation structure between the vertically polarized waves and the horizontally polarized waves, comprising a first input and output window (25) for the vertically polarized waves connecting to a second window (26) of the vertical diplexer (21), and which includes a third input and output window (28) for the horizontally polarized waves connecting to a fourth window (29) of the horizontal diplexer (22); with the first (25), second (26), third (28) and fourth (29) windows being inaccessible from outside the monobloc body, and the OTM module (23) having a fifth window (31) for connecting to an antenna.

2. Cross polarization multiplexer, according to claim 1, characterized in that the vertical polarization diplexer (21) and the horizontal polarization diplexer (22) are connected to a single board (34) which contains the transmitter circuit and receiver circuit, for which each of said diplexers (21, 22) has a sixth window (32) and a seventh window (33) for connecting to the board (34) containing the transmitter and receiver circuit; with said sixth and seventh windows (32, 33), as well as the fifth window (31) for connecting to the antenna of the OTM module (23), being arranged in the same plane and making up the only external access to the monobloc body.

3. Cross polarization multiplexer, according to claim 2, characterized in that the monobloc body is provided with a closure and protection cover (30) common to the OTM module (23) and the vertical (21) and horizontal (22) diplexers; said cover (30) comprising the fifth window (31) of the OTM module (23) for connecting to the antenna and the sixth (32) and seventh (33) input and output windows of each of the vertical (21) and horizontal (22) polarization diplexers for connecting to the board (34) containing the transmitter and the receiver circuit.

4. Cross polarization multiplexer, according to claim 3, characterized in that the external portion of the cover (30) comprises channelings (35) forming a mask for eliminating the millimeter radiations radiated by the board (34) containing the transmitter and the receiver circuit; and the cover (30) is so coupled over the board (34) forming a single assembly.

5. Cross polarization multiplexer, according to claim 1, characterized in that the square waveguide (24) of the OTM module (23) comprises, at its top, the fifth window (31) for connecting to the antenna, and includes some asymmetric steps (36), against which the first input and output window (25) for the vertically polarized waves is arranged, and at the bottom, wherein the asymmetric steps (36) end, comprises the third input and output window (28) for the horizontally polarized wave; with said first and third windows (25, 28) being arranged in a direction forming an angle of 90° in order to achieve the insulation for avoiding the inter-influence between the vertical (21) and horizontal (22) polarization diplexers.

6. Cross polarization multiplexer, according to claim 5, characterized in that the third input and output window (28) for the horizontally polarized waves of the OTM module (23) is rectangular and connected to an double-curve waveguide adapting unit (27) connected to the fourth window (29) of the horizontal polarization diplexer (22); with this connection being inaccessible from outside the monobloc body.

7. Cross polarization multiplexer, according to claim 6, characterized in that the first input and output window (25) for the vertically polarized waves of the OTM module (23) is rectangular and coincident with the second window (26) of the vertical polarization diplexer (21).

8. Cross polarization multiplexer, according to claim 3, characterized in that the fifth window (31) of the cover (30) shows a configuration selected from square and circular for connecting to the antenna.

9. Cross polarization multiplexer, according to claim 3, characterized in that the sixth and seventh windows (32, 33) of the cover (30) have a configuration selected from rectangular, square, circular and elliptical.

10. Cross polarization multiplexer, according to claim 8, characterized in that the cover (30) has a planar configuration so that the fifth, sixth and seventh windows (31, 32 and 33) are in one plane.

11. Cross polarization multiplexer, according to claim 1, characterized in that the conventional low-band and the high-band filters of the vertical (21) and horizontal (22) polarization diplexers are tuned to the same frequency bands.

12. Cross polarization multiplexer, according to claim 9, characterized in that the cover (30) has a planar configuration so that the fifth, sixth and seventh windows (31, 32 and 33) are in one plane.

13. Cross polarization multiplexer, according to claim 3, characterized in that the fifth window (31) of the cover (30) shows a configuration selected from square and circular for connecting to the antenna; sixth and seventh windows (32, 33) of the cover (30) have a configuration selected from rectangular, square, circular and elliptical, and in that the cover (30) has a planar configuration so that the fifth, sixth and seventh windows (31, 32 and 33) are in one plane.
